(19) United States
(12) Patent Application Publication
(10) Pub. No.: US 2009/0193980 A1
(43) Pub. Date: Aug. 6, 2009

(54) Popcorn cooking and dispensing appliance

(76) Inventor: Man-Yan Chan, Kowloon (HK)

Correspondence Address: ALIX YALE & RISTAS LLP, 750 MAIN STREET, SUITE 1400, HARTFORD, CT, 06103, US

(21) Appl. No.: 12/012,994

(22) Filed: Feb. 6, 2008

(51) Int. Cl. A47J 44/00; A47J 36/00

(52) U.S. Cl. 99/341; 99/355

(57) ABSTRACT

A popcorn cooking and dispensing appliance includes a housing, a cooking vessel located within the housing, a scoop located within the housing, an inclined surface adjacent to the cooking vessel and adapted to deliver popcorn ejected from the cooking vessel upon cooking/popping to the scoop when the scoop is at a first position, and a dispensing mechanism for moving the scoop from the first position to a second position whereat popcorn is dispensed from the scoop.

### BACKGROUND OF THE INVENTION

The present invention relates to popcorn dispensers. The invention more particularly, although not exclusively, relates to an appliance for both cooking and dispensing popcorn.

The traditional method of making popcorn is to fry the dried corn kernels in oil or butter for example and then place individual servings of the popcorn in a bag, paper bucket or other serving vessel.

Popcorn dispensing machines are known in which precooked popcorn is stored in a hopper and dispensed through the hopper outlet in individual servings to a bag, paper bucket or the like.

A popcorn cooking and dispensing appliance provides for dispensing individual servings of popcorn.

### SUMMARY

There is disclosed herein a popcorn cooking and dispensing appliance, comprising:

a housing;

a cooking vessel located within the housing;

a scoop located within the housing;

an inclined surface adjacent to the cooking vessel and adapted to deliver popcorn ejected from the cooking vessel upon cooking/popping to the scoop when the scoop is at a first position; and

a dispensing mechanism for moving the scoop from the first position to a second position whereat popcorn is dispensed therefrom.

Preferably, the inclined surface at least partly surrounds the cooking vessel.

Preferably, the scoop is mounted pivotally to the housing.

Preferably, the dispensing mechanism comprises a lever attached pivotally to the housing and a linkage connected between the lever and the scoop.

The appliance can further comprise a return spring connected between the housing and the lever.

Preferably, the housing includes a window through which the cooking vessel can be seen.

### BRIEF DESCRIPTION OF THE DRAWINGS

A preferred form of the present invention will now be described by way of example with reference to the accompanying drawings, wherein:

FIG. 1 is a schematic cross-sectional side elevation of a popcorn cooking and dispensing appliance with its dispensing scoop in a first/popcorn-receiving position; and

FIG. 2 is a schematic cross-sectional side elevation of the popcorn cooking and dispensing appliance with its dispensing scoop in a second/dispensing position; and

### DESCRIPTION OF THE PREFERRED EMBODIMENT

In the accompanying drawings there is depicted schematically a popcorn cooking and dispensing appliance 10. The appliance 10 comprises a housing 11 which would typically be situated upon a benchtop, table or stand in use. The appliance 10 includes an internal cooking vessel 12 having a heater 15 therebelow. The heater 15 supports the cooking vessel 12 and is in turn supported by support post 21 within the housing 11.

Surrounding the cooking vessel 12 is an inclined surface 23 which slopes downwardly toward a scoop 20. When corn kernels are cooked and popped within the cooking vessel 12, they self-eject through the top opening of the cooking vessel 12 and land on the inclined surface 23 from where they slide into the scoop 20. A window 22 is provided at the front and/or sides of the housing 11 to enable viewing of the cooking vessel 12, viewing of the popping action of the popcorn and its migration across the inclined surface 23 to the scoop 20.

The scoop 20 is mounted pivotally at 27 to the housing 11 and includes a dispensing lip 14. From the pivot point 27, there extends an arm 19 which is angularly fixed with respect to the scoop 20. At the distal end of the arm 19, there is a connection point 26. A handle 13 is mounted pivotally at 24 to the housing 11. The handle includes an extension 29 with connection point 25 at its distal end. The extension 29 is angularly fixed with respect to the main portion of the handle. A link 17 extends between connection point 25 of handle extension 29 and connection point 26 of the arm 19. The link 17 can pivot with respect to both arm 19 and handle extension 29. A tension return spring 16 extends from connection point 25 of the handle extension 29 to a fixed connection point 28 of the housing 11.

When the handle 13 is drawn forward as indicated by the arrow in FIG. 2, connection point 25 moves to the right to apply tension to spring 16. At this time, link 17 draws arm 19 to the right to cause scoop 20 and dispensing lip 14 to rotate anti-clockwise to the position depicted in FIG. 2 whereupon popcorn from the scoop 20 can slide over the lip 14 to a receiving vessel, bag or the like held therebelow by a user.

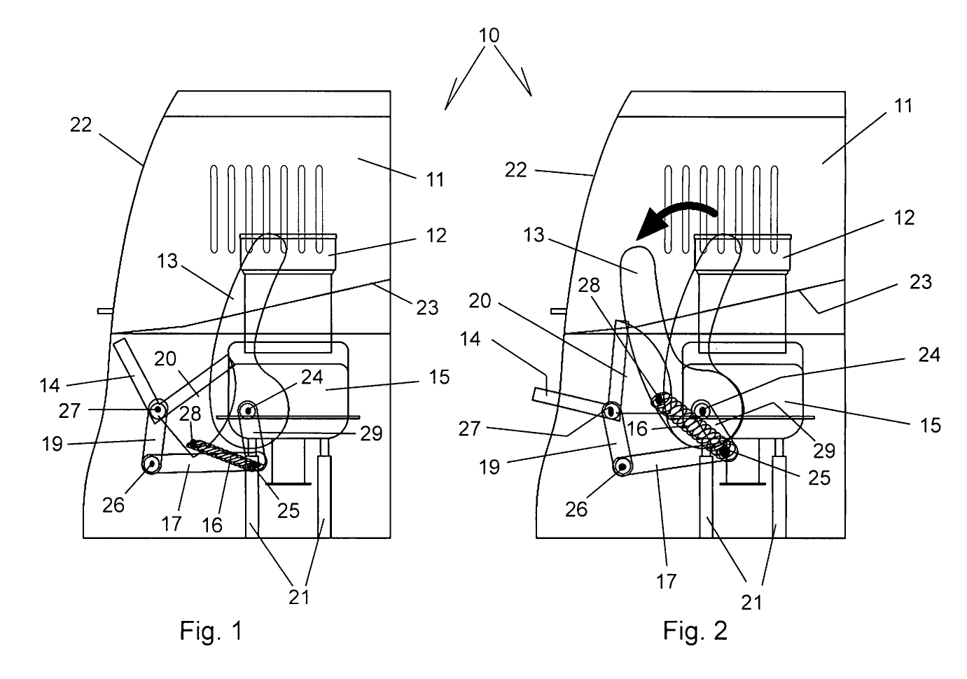

When handle 13 is released, the return spring 16 draws back on connection point 25 to return handle 13 to its initial position as depicted in FIG. 1, and during this movement, the link 17 pushes back on arm 19 to return scoop 20 and dispensing lip 14 to the position depicted in FIG. 1 whereat a serving of popcorn located upon the inclined surface 23 will refill the scoop 20.

It should be appreciated that modifications and alterations obvious to those skilled in the art are not to be considered as beyond the scope of the present invention. For example, rather than providing a hand-operated handle 20, a motorised mechanism can be provided to effect pivotal movement of scoop 20 and dispensing lip 14. Furthermore, rather than providing a pivoting scoop, a sliding drawer device and appropriately modified dispensing mechanism could be provided.

1. A popcorn cooking and dispensing appliance, comprising:
a housing;
a cooking vessel located within the housing;
a scoop located within the housing;
an inclined surface adjacent to the cooking vessel and adapted to deliver popcorn ejected from the cooking vessel upon cooking/popping to the scoop when the scoop is at a first position; and
a dispensing mechanism for moving the scoop from the first position to a second position whereat popcorn is dispensed therefrom.

2. The appliance of claim 1, wherein the inclined surface at least partly surrounds the cooking vessel.

3. The appliance of claim 1, wherein the scoop is mounted pivotally to the housing.

4. The appliance of claim 3, wherein the dispensing mechanism comprises a lever attached pivotally to the housing and a linkage connected between the lever and the scoop.

5. The appliance of claim 4, further comprising a return spring connected between the housing and the lever.

6. The appliance of claim 1, wherein the housing includes a window through which the cooking vessel can be seen.
